(19) United States
(12) Patent Application Publication
(10) Pub. No.: US 2015/0284285 A1
(43) Pub. Date: Oct. 8, 2015

(54) DEVICE AND METHOD FOR SUPPORTING AND FIXING OF A GLASS PLATE

(71) Applicant: MDI SCHOTT ADVANCED PROCESSING GMBH, Mainz (DE)

(72) Inventor: Bernd Christoph Hoetzel, Woerrstadt (DE)

(73) Assignee: MDI Schott Advanced Processing GmbH, Mainz (DE)

(21) Appl. No.: 14/437,597

(22) PCT Filed: Oct. 21, 2013
(86) PCT No.: PCT/EP2013/071956

§ 371 Date: Apr. 22, 2015

(30) Foreign Application Priority Data
Oct. 23, 2012 (DE) 10 2012 219 332.4

(51) Int. Cl. C03B 33/03

(52) U.S. Cl. CPC C03B 33/03

(57) ABSTRACT

The present invention relates to a device for supporting and fixing a pane made of a brittle material such as a glass pane (12), in particular a thin glass pane (12), during a cutting process in which the glass pane (12) is cut along a cutting edge (34), comprising a main part (14) through which a gas can flow, a gas conducting device (18) for supplying gas to the main part (14) and conducting the gas through the main part (14), said glass pane (12) being supportable on the gas exiting the main part (14), and a fixing unit (20) for fixing the glass pane (12) relative to the device (10₁), said fixing unit interacting with the glass pane (12) such that the glass pane (12) comes into contact with the main part (14) in a contact area (24) during the cutting process and the cutting edges (34) are lifted by the exiting gas outside of the contact area (24) and positioned at a distance from the main part (14). Moreover the invention relates to a respective method.

The present invention relates to a device for supporting and fixing a pane made of a brittle material such as a glass pane, in particular a thin glass pane, during a cutting process in which the glass pane is cut along a cutting edge, the device comprising a main part through which a gas can flow, and a gas conducting device for supplying gas to the main part and conducting the gas through the main part, said glass pane being supportable on the gas exiting the main part. Moreover, the present invention relates to a corresponding method.

Methods for cutting glass panes can basically be subdivided into two categories. One the one hand it is possible to completely cut through the glass pane along a cutting edge in one work step or on the other hand to partly cut or scratch along a line and subsequently break the glass pane wherein the line defines the breaking edge. As a consequence a cutting edge is generated by means of the first method whereas a scratch and breaking edge is generated by the latter method. In the following the term cutting edge should stand for all edges generated by cutting the glass pane. Which of the two methods is employed is determined by the material and the thickness of the work piece. In both cases a laser may be employed to completely cut through or to partly cut the glass pane. The partial cutting may also be performed by a scratcher, e.g. made of diamond, or a cutting wheel. Within the context of the present application the glass pane should stand for all panes made of brittle material to which the problems subsequently discussed apply.

In both methods the glass pane must be loaded to a support plate on which it needs to be fixed. The fixation may be done by a negative pressure or a vacuum so that the glass pane is pulled to the support plate and thereby fixed to the support plate. Due to production limitations the support plate is never ideally plane so that a certain unevenness cannot be avoided. Due to the unevenness particularly in thin glass panes, i.e., glass panes having a glass thickness of <200 μm, tension and tension peaks are introduced into the glass pane in an uncontrolled manner which may lead to a breakage of the glass pane in the worst case but in any case lead to a cutting edge of minor quality in case the tension is extending to the cutting edge. Furthermore in this case it is difficult to completely cut through the glass pane without damaging the support plate so that this way of fixing is mainly suited for scratching and subsequent breaking, the latter being performed outside the support plate.

It is known in the prior art to face the problem of the unevenness of the support plate by supporting the glass pane on a gas cushion, in particular on an air cushion, being provided by means of compressed air, wherein the gas used may be freely chosen according to the given application. The tension is thereby reduced, however, additional measures have to be taken for fixing the glass pane as the position of the glass pane, neither with respect to the height nor to the side, cannot be clearly defined by the air cushion, which is, however, a necessary prerequisite to cut the glass pane along a clearly defined cutting edge. It is thus necessary to employ fixing devices that contact the glass pane. However, the flexibility during the cutting process is reduced as the progression of the cutting edge needs to be adjusted to the position of the fixing device.

A device for supporting and fixing a glass pane during the cutting process is disclosed in EP 1 044 930 A2 in which the glass pane is broken along a scratch line. The device comprises two girders through which gas can flow, the gas being provided via corresponding lines. A positive pressure and a negative pressure can be provided on the supporting surface of the girder. By applying a positive pressure the glass pane 3 can be easily moved to the desired position and by applying a negative pressure the glass pane is fixed in the desired position. By the application of a negative pressure the glass pane is contacting the girder. Two girders are provided being spaced from each other and forming a gap. In order to arrange the cutting edge apart from the main part the glass pane has to be located so that cutting edge is positioned in the area of the gap.

A device for supporting and fixing a glass pane during a cutting process is shown in EP 0 457 751 in which the glass pane is cut along a cutting edge. A main part is provided in form of a suction box through which gas can flow. The glass pane is pulled to the suction box due to the negative pressure. The glass pane is broken along a cutting edge by means of a movable ledge. The cutting edge needs to be placed inside a gap of the suction box in which also the movable ledge is located. Also in this case a gap is required to locate the cutting edges apart from the main part.

The present invention thus aims to provide a device and a method for supporting and fixing of a glass pane that enable the flexible cutting of the glass pane with a high quality of the resulting cutting edges without being limited to a given cutting method.

The aim is reached by means of a device as initially described comprising the features of the characterizing part of claim 1 as well as by means of a method according to claim 10₁. Advantageous embodiments of the device and the method are given in the depending claims.

Due to the fact that the inventive device comprises a fixing unit for fixing the glass pane relative to the device, said fixing unit interacting with the glass pane such that the glass pane comes into contact with the main part in a contact area during the cutting process and the cutting edges are lifted by the exiting gas outside of the contact area and positioned at a distance from the main part, following technical effects and advantages can be reached: Due to the contact of the glass pane with the main part within the contact area the glass pane is fixed in its position so that it cannot be displaced during the cutting process. The exiting gas causes that the glass pane is lifted outside the contact area and removed from the main part such that the cutting edges are exposed. Consequently, the glass pane can be completely cut through or scratched, preventing the damage of the main part. There is no limitation to any cutting methods. Although tension is introduced into the glass pane by the gas exiting the main part, the tension is equally distributed within the glass pane by the use of the inventive device which is in contrast to the unevenness of known support plates as initially discussed. Stress peaks in particular in the area of the cutting edges are avoided. The quality of the cutting edges can be increased. Moreover, mechanical properties of the glass pane to be treated can be considered by the volume flow of the gas exiting the main part so that glass panes of different thickness, ductility and hardness can be cut without introducing high tension that may lead to a damage of the glass pane to be cut. Preferably, air is used as gas.

Preferably the gas conducting device comprises a number of channels for conducting the gas through the main part. The channels are easy to produce and can be positioned as most convenient for the given application. The gas flow, in particular the air flow, can be selectively guided, moreover, the channels can be cleaned in an easy way in case they should be clogged during the operation of the device, e.g., by cutting dust.

An advanced embodiment of the inventive device is characterized by a layer, in particular a sinter layer, applied on the main part, through which gas can flow, and being applied on the main part such that the sinter layer comprises the contact area. A layer applied to the main part through which the gas can flow has the advantage that it is superfluous to provide a number of channels for guiding the gas through the main part. Consequently the main part can be more excessively loaded. Beyond that the layer can be designed in a way that it is particularly suited for the conditions emerging during the cutting process, thereby protecting the main part. Particularly a layer embodied as a sinter layer through which gas can flow can be designed in a way that it is very heat resistant so that this embodiment is particularly suited for laser cutting as laser beams unintentionally focused on the sinter layer are not damaging the sinter layer or only in a negligible extent. It is further possible to provide the sinter layer in a very plane and even way, at the same time providing a large hardness so that no or only little tension is introduced into the glass pane via the contact area. Due to the achievable evenness the glass pane may still be scratched in case the gas or air supply is stopped for whatever reasons. Thereby the reliability of the device is enhanced.

In a preferred embodiment the fixing unit comprises negative pressure means for providing a negative pressure or a vacuum for fixing the glass pane with reference to the device. Taking advantage of the sucking effect of the negative pressure or the vacuum has the benefit that the glass pane can be fixed to the support plate without the aid of further components. A quick fixation of the glass pane can be reached, wherein the fixation can be flexibly adjusted. In case the position of the glass pane is to be changed the negative pressure means may be shortly switched off and the glass pane re-positioned as desired. As soon as the negative pressure means are switched on again the glass pane is fixed again.

A particularly preferred embodiment is characterized in that the negative pressure means comprise one or more outlet channels passing through the main part and the sinter layer and/or a vacuum pump interacting with the outlet channels for withdrawing a part of the gas exiting the main part and the sinter layer. Due to the fact that the outlet channel passes through the main part and the sinter layer the inventive device can be designed in a compact way, thereby being space-saving. The vacuum pump may be fixed directly underneath the main body, thereby saving further available space. Commercially available vacuum pumps can be employed such that the device can be provided in a cost-saving way. In case the main part comprises a sinter layer it is not mandatory that the outlet channels completely pass through the sinter layer. It is sufficient that the outlet channels extend into the sinter layer or interact with the sinter layer such that a part of the exiting gas can be evacuated to provide a negative pressure at the desired location.

In a preferred embodiment shut-off devices are arranged in the outlet channel for selectively closing and releasing the air stream flowing through the outlet channels. Areas of negative pressure can hereby be selectively provided or switched off. The closer the cutting edges are located to the gas-flown outlet channels, the higher the tension in the area of the break or cutting edges, leading to a reduced quality of the break or cutting edges. In case the tension is exceeding a critical value due to the proximity of the break or cutting edges to the gas-flown outlet channels the tension in the area of the cutting edges may be reduced simply by closing the respective outlet channels without the need to re-position the glass pane. Hereby it is possible to cut the glass pane in strips without re-positioning the glass pane. Areas of vacuum and negative pressure can be selectively added considering the current position of the cutting edge.

Preferably the negative pressure means further comprise a guiding device for guiding the stream of the gas exiting the main part and the sinter layer. The guiding device may be embodied as a sleeve or as a rubber body on which the glass pane is placed. The guiding device impresses a main direction to the stream of gas exiting the sinter layer. The gas exiting the sinter layer on the side of the guide device facing the outlet channel is mainly guided to the outlet channel and evacuated when the glass pane is placed on the guiding device, thereby generating a negative pressure. The gas exiting on the side opposing the outlet channel is creating a positive pressure and thereby lifts the glass pane before it is exiting the device sideways. The guiding device enables to selectively divide and locate areas of positive and negative pressure.

In a further embodiment that the fixing unit comprises magnetic, magnetizable or magnetized means. Magnetic means are means that are magnetic per se, such as iron, nickel or cobalt. They are attracted or repelled by permanent magnets. In case the means is magnetized it has the properties of a permanent magnet. Magnetizable means may be magnetized by interaction with a permanent magnet. Due to the attractive force of the magnetic means the glass pane is fixed with reference to the device. Embodiments are possible in which the magnetic force is generated by applying an electric field. Accordingly the magnetic force can be abolished by switching off the electric field. The glass pane can be selectively fixed or released. It is further conceivable that the glass pane itself comprises magnetic components that are attracted by a respective design of the device, thereby fixing the glass pane.

It has turned out to be beneficial when the sinter layer comprises magnetic, magnetizable or magnetized particles interacting with magnetic, magnetizable or magnetized bodies applicable to the glass pane for fixing the glass pane. In this embodiment the magnetic, magnetizable or magnetized bodies are provided on the side of the glass pane opposing the sinter layer which enables to easily define and change of the contact area, e.g., manually or by means of a gripper mechanism. Depending on the thickness of the glass pane the own weight of the bodies may be used for the fixation of the glass pane. This is particularly advantageous for thicker glass panes where very large magnetic fields are required to achieve a sufficient fixation. Due to the fact that the sinter layer comprises magnetic, magnetizable or magnetized particle no additional steps are required to generate the attracting effect of the magnetism. The device can thus be kept compact at a manageable complexity.

The aim underlying the present invention is also reached by a method for supporting and fixing a pane made of a brittle material such as a glass pane, in particular a thin glass pane, during a cutting process in which the glass pane is cut along a cutting edge on a device, the device comprising a main part through which a gas can flow, the method comprising following steps:
supplying gas to the main part and conducting the gas through the main part by means of a gas conducting device,
supporting the glass pane on the gas exiting the main part, and
fixing the glass pane with reference to the device by means of a fixing unit, the fixing unit interacting with the glass pane such that the glass pane is contacting the main part during the cutting process within a contact area and the cutting edges are lifted by the exiting gas outside the contact area and are positioned at a distance from the main part.

The advantages and technical effects achievable by the inventive method are the same as discussed for the inventive device.

A preferred embodiment is distinguished in that the step of fixing the glass pane with reference to the device comprises providing a negative pressure or a vacuum by negative pressure means. Also in this embodiment the same advantages and technical effects as discussed for the respective embodiment of the device may be achieved. Particularly the unevenness of the supporting plate does not lead to an uncontrolled intake of tension into the glass pane that may lead to breakage. Moreover, there is no limitation to a specific cutting method as the cutting edges are exposed and the main part is not damaged during the cutting process.

Another embodiment of the inventive method is characterized in that the step of fixing the glass pane with reference to the device comprises the interaction of magnetic, magnetizable or magnetized particles of a sinter layer applied on the main part with magnetic, magnetizable or magnetized bodies applicable on the glass pane. Also in this embodiment the same advantages and technical effects as discussed for the respective embodiment of the device may be achieved.

The invention is exemplified in detail by means of preferred embodiments by reference to the attached drawings.

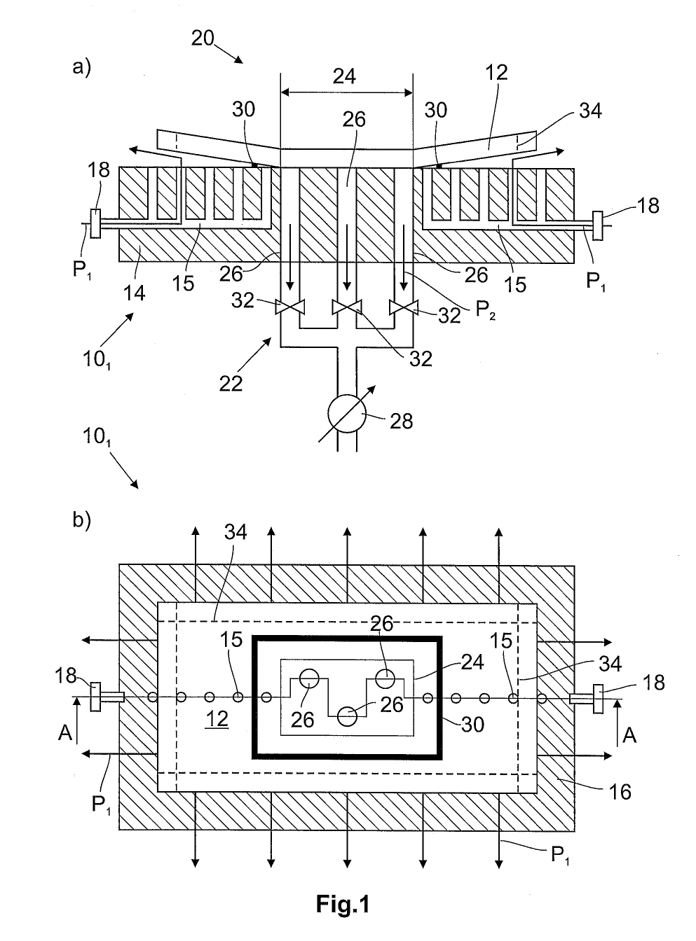

FIG. 1a) is a cross section through a first embodiment of an inventive device,

FIG. 1b) is a schematic top view of the embodiment of the inventive device shown in FIG. 1a)

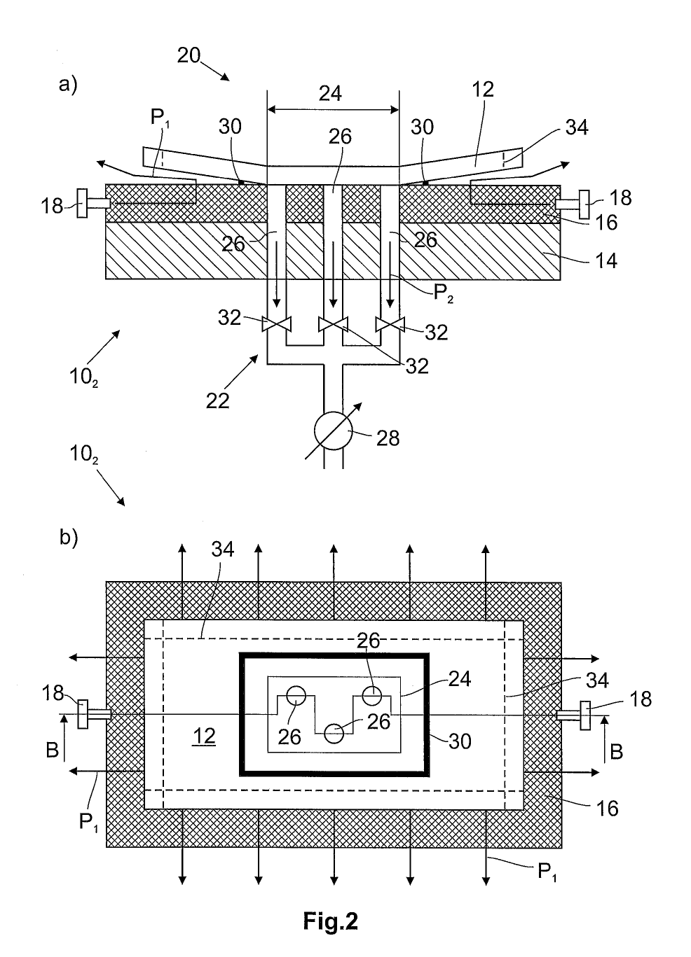

FIG. 2a) is a cross section through a second embodiment of an inventive device,

FIG. 2b) is a schematic top view of the embodiment of the inventive device shown in FIG. 2a),

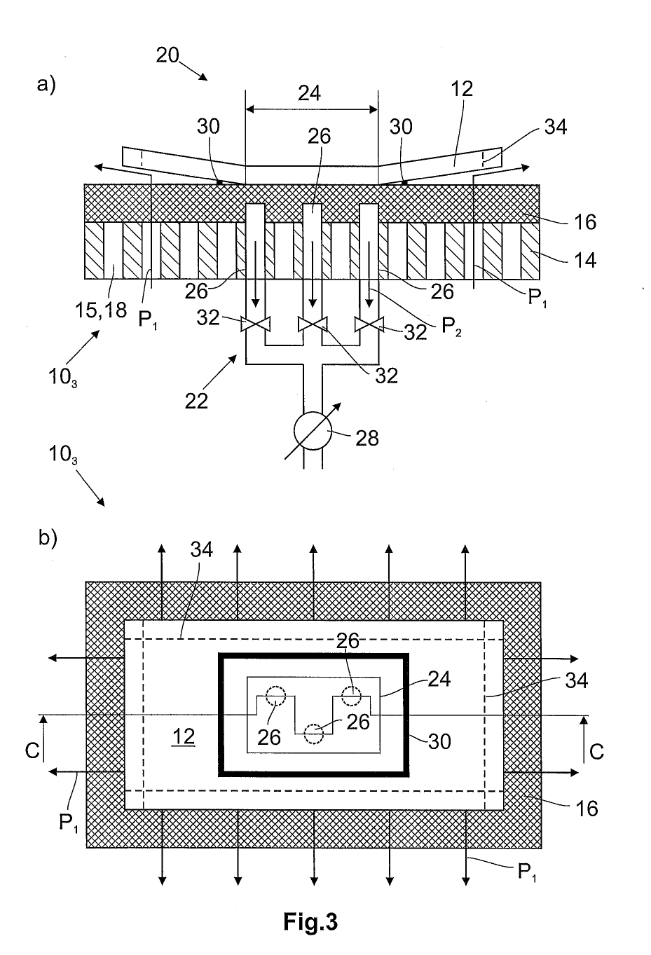

FIG. 3a) is a cross section through a third embodiment of an inventive device,

FIG. 3b) is a schematic top view of the embodiment of the inventive device shown in FIG. 3a),

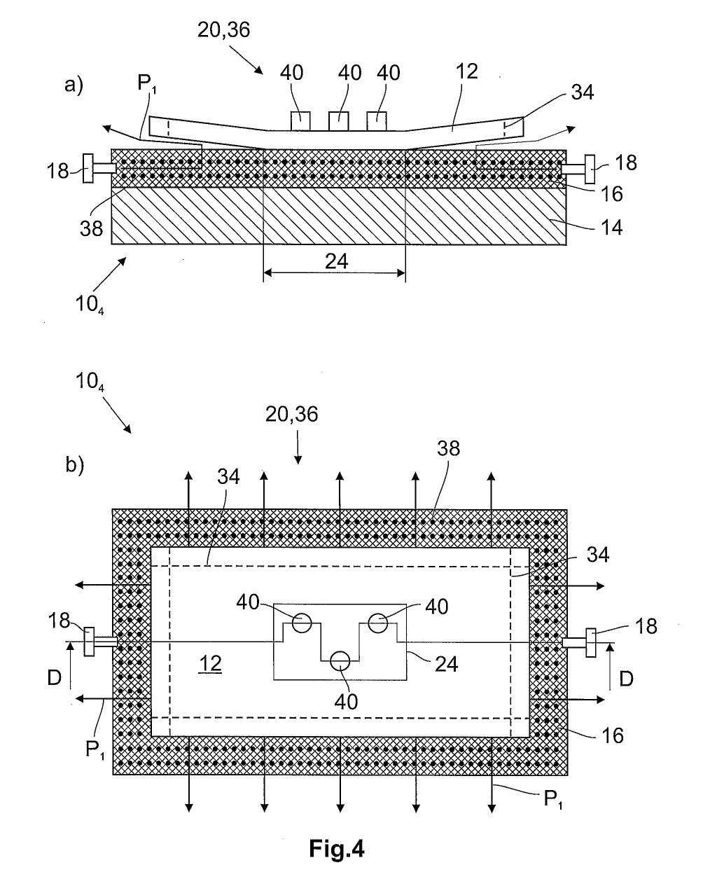

FIG. 4a) is a cross section through a fourth embodiment of an inventive device,

FIG. 4b) is a schematic top view of the embodiment of the inventive device shown in FIG. 4a).

In FIG. 1a) a first embodiment of the inventive device 10₁ for supporting and fixing a glass pane 12, in particular a thin glass pane 12, during a cutting process is shown by means of a principle representation. However, the inventive device 10₁ may also be used for cutting panes made of any brittle material. The device 10₁ comprises a main part 14 through which gas can flow. To this end the main part 14 comprises a gas conducting device 18 that comprises a number of channels 15. For providing gas, preferably compressed air, to the channels 15 the gas conducting device 18 comprises further elements that are not shown, e.g., hoses, valves, pressure reducers, compressors and pressure tubes. The compressed air flows through the channels 15 in the direction indicated by the arrows P₁. The channels 15 are designed in a way that the gas flowing through the channels 15 provides a gas or air cushion on which the glass pane 12 may be deposited.

Moreover the inventive device 10₁ comprises a fixing unit 20 by which the glass pane 12 is fixable with reference to the device 10₁. In the shown embodiment the fixing unit 20 comprises negative pressure means 22 that are designed such that the glass pane 12 is contacting the main part 14 in a contact area 24 in operation of the device 10₁, thereby fixing the glass pane 12 relative to the device 10₁. In the shown example the negative pressure means 22 comprise three outlet channels 26 passing through the main part 14, the number of outlet channels 26 can be chosen arbitrarily. Further the negative pressure means 22 comprise a vacuum pump 28 by which a part of the gas that is exiting the main part 14 in the vicinity of the free end of the outlet channels 26 can be evacuated as indicated by the arrows P₂. As a consequence a negative pressure is generated and the glass pane 12 is pulled towards the main part 14, thereby being fixed in its position. To define the contact area 24 more clearly a guiding device 30 is positioned on the sinter layer 16 on which the glass pane 12 is deposited. The guiding device 30 may be a sleeve made of metal or an elastic rubber. Hereby it is defined which part of the gas is evacuated for fixing the glass pane 12 and which part serves for providing a gas or air cushion for supporting the glass pane 12.

Moreover shut-off devices 32 are provided in the outlet channels 26 that enable the selective opening and closing of the outlet channels 26 and thereby releasing or interrupting the air flow. Thereby the contact area 24 may be increased or decreased as well as its position selectively changed. The shut-off devices 32 may be embodied as valves or gate valves.

Beyond that cutting edges 34 are shown along which the glass pane 12 may be cut with a cutting tool not shown, e.g., a CO₂-Laser, a diamond scratcher or a cutting wheel. It is evident that the cutting edges 34 are exposed, having a distance to the main part 14 such that the main part 14 is not damaged when cutting the glass pane 12. The gas exiting the main part 14 outside the guiding device 30 lifts the glass pane 12 while the glass pane 12 inside the guiding device 30 is pulled towards the main part 14 by the negative pressure. The glass pane 12 is bent and tension is introduced into the glass pane 12. However, the tension is introduced very uniformly and its magnitude can be controlled by the volume flow of the gas so that the glass pane 12 is not damaged and a high quality of the cutting edges 34 is obtainable. The conveying capacity of the vacuum pump 28 as well as the volume flow of the gas guided through the main part 14 can be adjusted to each other and changed by means of a controlling device 10₁ not shown.

The course of the bending of the glass pane 12 and the contact area 24 are only principally shown in the drawings and do not demand accordance to the courses that attune in operation of the inventive device 10₁.

In FIG. 1b) the embodiment shown in FIG. 1a) is shown by means of a top view. It is evident that the cutting edges 34 run in a certain distance to the contact area 24 and to the guiding device 30. Further the cutting plane A-A used for FIG. 1a) is shown.

In FIG. 2a) a second embodiment of the inventive device 10₂ is shown by means of a cross section. As opposed to the first embodiment a sinter layer 16 is applied to the main part 14 through which gas can flow due to its porosity. As a consequence no channels 15 for guiding the gas are needed. For guiding the gas to the glass pane 12 in the desired way the sinter layer 16 may be provided with air-impermeable layers at its edges and surfaces or may be sealed. Further, the main part 14 may comprise air-impermeable sections such that the gas may only exit via the free surface of the sinter layer 16 as indicated by the arrow P₁. The gas is introduced into the sinter layer 16 via the gas conducting device 18. The outlet channels 26 pass through the main body and the sinter layer 16.

In FIG. 2b) the embodiment shown in FIG. 2a) is shown by means of a top view. It is evident that the cutting edges 34 have a certain distance to the contact area 24. Moreover, the cutting plane B-B used for FIG. 2a) is shown.

In FIG. 3a) a third embodiment of the inventive device 10₃ is shown that differs from the second embodiment in that the outlet channels 26 are only partly extending into the sinter layer 16 and do not reach the contact area 24. Moreover the gas conducting device 18 comprises a number of the channels 15 that completely run through the main part 14 and the sinter layer 16 and can be applied with compressed air in a way not further shown.

In FIG. 3b) the embodiment shown in FIG. 3a) is shown by means of a top view. It is evident that the cutting edges 34 have a certain distance to the contact area 24. Moreover, the cutting plane C-C used for FIG. 3a) is shown.

In FIG. 4a) a fourth embodiment of the inventive device 10₄ is shown. To a large extent it equals the embodiments shown in FIGS. 2 and 3, however, the fixing unit 20 is designed in a different way. In the fourth embodiment the fixing unit 20 comprises magnetic, magnetizable or magnetized means 36. More specifically, the sinter layer 16 comprises magnetic, magnetizable or magnetized particles 38 that interact with magnetic, magnetizable or magnetized bodies 40 arranged on the glass pane 12 for fixing the glass pane 12. Due to the attractive effect of the particles 38 and the bodies 40 the glass pane 12 is pressed to the sinter layer 16 inside the contact area 24 and is thus fixed. Again the gas exiting the sinter layer 16 has the effect that the glass pane 12 is lifted outside the contact area 24 such that the cutting edges 34 are exposed. The attractive magnetic effect may be induced and its magnitude changed by applying an electric field to the sinter layer 16 and/or the main body (not shown).

In FIG. 4b) the embodiment shown in FIG. 4a) is shown by means of a top view. It is evident that the cutting edges 34 have a certain distance to the contact area 24. Moreover, the cutting plane D-D used for FIG. 4a) is shown.

### REFERENCE LIST

10₁, 10₁-10₄ Device
12 glass pane
14 main part
15 channel
16 sinter layer
18 gas conducting device
20 fixing unit
22 negative pressure means
24 contact area
26 outlet channel
28 vacuum pump
30 guiding device
32 closing device
34 cutting edge
36 magnetic, magnetizable or magnetized means
38 magnetic, magnetizable or magnetized particles
40 magnetic, magnetizable or magnetized body
P arrow

1. A device for supporting and fixing a pane made of a brittle material such as a glass pane (12), in particular a thin glass pane (12), during a cutting process in which the glass pane (12) is cut along a cutting edge (34), comprising
a main part (14) through which a gas can flow,
a gas conducting device (18) for supplying gas to the main part (14) and conducting the gas through the main part (14), said glass pane (12) being supportable on the gas exiting the main part (14), and
a fixing unit (20) for fixing the glass pane (12) relative to the device (101), said fixing unit interacting with the glass pane (12) such that the glass pane (12) comes into contact with the main part (14) in a contact area (24) during the cutting process and the cutting edges (34) are lifted by the exiting gas outside of the contact area (24) and positioned at a distance from the main part (14).

2. The device according to claim 1, wherein the gas conducting device (18) comprises a number of channels (15) for conducting the gas through the main part (14).

3. The device according to claim 1, comprising a layer, in particular a sinter layer, applied on the main part (14), through which gas can flow, and being applied on the main part (14) such that the sinter layer (16) comprises the contact area (24).

4. The device according to claim 1, wherein the fixing unit (20) comprises negative pressure means (22) for providing a negative pressure or a vacuum for fixing the glass pane (12) with reference to the device (101).

5. The device according to claim 4, wherein the negative pressure means (22) comprise one or more outlet channels (26) passing through the main part (14) and the sinter layer (16) and/or a vacuum pump (28) interacting with the outlet channels (26) for withdrawing a part of the gas exiting the main part (14) and the sinter layer (16).

6. The device according to claim 5, wherein shut-off devices (32) are arranged in the outlet channel (26) for selectively closing and releasing the air stream flowing through the outlet channels (26).

7. The device according to claim 4, wherein the negative pressure means (22) further comprise a guiding device (30) for guiding the stream of the gas exiting the main part (14) and the sinter layer (16).

8. The device according to claim 1, wherein the fixing unit (20) comprises magnetic, magnetizable or magnetized means (36).

9. The device according to claim 8, wherein the sinter layer (16) comprises magnetic, magnetizable or magnetized particles (38) interacting with magnetic, magnetizable or magnetized bodies applicable to the glass pane (12) for fixing the glass pane (12).

10. A method for supporting and fixing a pane made of a brittle material such as a glass pane (12), in particular a thin glass pane (12), during a cutting process in which the glass pane (12) is cut along a cutting edge (34) on a device (101), the device comprising a main part (14) through which a gas can flow, the method comprising following steps:
supplying gas to the main part (14) and conducting the gas through the main part (14) by means of a gas conducting device (18),
supporting the glass pane (12) on the gas exiting the main part (14), and
fixing the glass pane (12) with reference to the device (101) by means of a fixing unit (20), the fixing unit (20) interacting with the glass pane (12) such that the glass pane (12) is contacting the main part (14) during the cutting process within a contact area (24) and the cutting edges (34) are lifted by the exiting gas outside the contact area (24) and are positioned at a distance from the main part (14).

11. The method according to claim 10, wherein the step of fixing the glass pane (12) with reference to the device (101) comprises providing a negative pressure or a vacuum by negative pressure means (22).

12. The method according to claim 10, wherein the step of fixing the glass pane (12) with reference to the device (101) comprises the interaction of magnetic, magnetizable or magnetized particles (38) of a sinter layer (16) applied on the main part (14) with magnetic, magnetizable or magnetized bodies (40) applicable on the glass pane (12).
